(19) United States
(12) Patent Application Publication
(10) Pub. No.: US 2006/0113175 A1
(43) Pub. Date: Jun. 1, 2006

(54) Electronic apparatus including operation button

(75) Inventors: Tatsuya Uchizono, Echizen-city (JP); Toshifumi Sasaoka, Echizen-city (JP); Yoshikazu Yonezu, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/287,213

(22) Filed: Nov. 28, 2005

(30) Foreign Application Priority Data
Nov. 30, 2004 (JP) 2004-347492

(51) Int. Cl. H01H 13/14

(52) U.S. Cl. 200/341

(57) ABSTRACT

An electronic apparatus including an operation button which downsizes a space inside the electronic apparatus by disposing a component such as a switch which is disposed behind the operation button close to a rear portion of the operation button is provided. The button part 10 is locked by the locking hooks 25 provided at a front surface side of the button frame 20, and when the button part 10 and the button frame 20 are integrally provided, the locking hooks 25 are not disposed at the back surface side of the button frame 20, thus making it possible to secure a space part at a rear of the button frame 20, and making it possible to dispose the switch 4 or the like close to the rear part 20A of the button frame 20.

The present application is based on and claims priority of Japanese patent application No. 2004-347492 filed on Nov. 30, 2004, the entire contents of which are hereby incorporated by reference.

### BACKGROUND OF THE INVENTION

1. Field of the Invention

The present invention relates to an electronic apparatus including a push-button type operation button, and particularly relates to an electronic apparatus including an operation button which performs an on/off operation of a switch by an operation of the operation button when the operation button of the electronic apparatus such as a television image receiver is operated.

2. Description of the Related Art

Conventionally, an electronic apparatus in which a push-button type operation button is disposed to project at a front surface or the like of the electronic apparatus, and an on/off operation of a power supply can be performed by operating the operation button by pressing it is generally used. As such a prior art, Japanese Patent Laid-open Publication No. 10-12083 (patent document 1) proposes a push button in which a push-button body part is mounted to a case part by locking a claw part provided to extend rearward to project from both end portions of the push-button body part at a locking hole of the case part fixed inside an apparatus, and which is operated by pressing a front portion of the button body part with a finger into motion to press a switch disposed behind the case part in the apparatus by a push rod inserted into a through-hole of the case part at a rear of the push-button body part.

In the above described patent document 1, however, a tip end of the claw part projects to a rear of the case part in the state in which the push-button body part is mounted to the case part because the claw part for mounting the push-button body part to the case part projects to a rear side which is the case part side, and therefore, it is not a preferable structure to dispose a component such as a switch and a member in the state in which they are in close vicinity to the rear portion of the case part. In addition, the shape of the push-button body part is complicated, and for example, when plating is applied to a surface of the push-button body part, for example, masking or the like is required so that plating is not applied to the claw part, and since the shape itself is complicated, plating itself becomes difficult. Further, since the claw part projects to the rear side of the case part, it is required to take a creeping distance by separating a board and the claw part in a structure in which plating is applied to the button body part and the board is disposed at the rear side of the case part.

### SUMMARY OF THE INVENTION

The present invention is made in view of the above described problems, and has an object to provide an electronic apparatus including an operation button in which a component such as a switch disposed behind the operation button is disposed in a state in which it is close to a rear portion of the operation button to reduce a space in the electronic apparatus.

An electronic apparatus including an operation button of claim 1 of the present invention is, in an electronic apparatus including an operation button constructed by a button part which is operated by directly touching it and a button frame which is mounted with the button part and turns on/off a switch by pressing the switch disposed at a board inside an electronic apparatus as separate members, characterized in that the aforesaid button part is disposed in a state in which the button part is projected from a hole part formed in a cabinet of the electronic apparatus, locking means are provided at a front surface side of the aforesaid button frame, the aforesaid button part is locked by the locking means, and the aforesaid button part and the aforesaid button frame are integrally provided.

The electronic apparatus including an operation button of claim 2 of the present invention is, in the electronic apparatus including an operation button according to claim 1, characterized in that the aforesaid locking means are hooked locking hooks.

By the construction of claim 1 or 2, by mounting the button part to the button frame by the locking means such as the locking claw of the front surface side of the button frame, the locking means are not disposed at the back surface side of the button frame in the state in which the button part is mounted to the button frame, and therefore, it is possible to secure a space part at a rear portion of the button frame, thus making it possible to dispose the switch or the like in the state in which the switch is close to the rear portion of the button frame.

The electronic apparatus including an operation button of claim 3 of the present invention is, in the electronic apparatus including an operation button according to claim 1 or 2, characterized in that a covering layer having electric conductivity is included on a surface of the aforesaid button part, and a material of the aforesaid button frame is made of a resin which does not have electric conductivity.

According to the construction of claim 3, the static electricity charged at the button part can be shut off by the button frame which does not have electric conductivity in the state in which the button part including a covering layer having electric conductivity on a surface is mounted to the resin button frame, and therefore, even if the switch is disposed at the back surface side of the button frame, a short circuit by static electricity to the board via the switch from the button part can be prevented.

### BRIEF DESCRIPTION OF THE DRAWINGS

FIG. 1 is a perspective view showing an electronic apparatus in an embodiment 1.

FIG. 2 is an exploded perspective view of an operation button constituted of a button part and a button frame part included in the electronic apparatus in the same embodiment.

FIG. 3 is a perspective view showing a state in which the button part and the button frame are integrally provided in the same embodiment.

FIG. 4 is a side view of the button part in the same embodiment.

FIG. 5 is a side view showing a state in which the button frame mounted with the button part is mounted to a cabinet of the electronic apparatus in the same embodiment.

FIG. 6 is a sectional view showing a state in which the button frame mounted with the button part is mounted to the cabinet of the electronic apparatus in the same embodiment.

FIG. 7 is an exploded perspective view of an operation button constituted of a button part and a button frame part included in an electronic apparatus in embodiment 2.

FIG. 8 is a perspective view showing a state in which the button part and the button frame are integrally provided in the same embodiment.

FIG. 9 is a side view showing a state in which the button frame mounted with the button part is mounted to a cabinet of the electronic apparatus in the same embodiment.

FIG. 10 is a sectional view showing a state in which the button frame mounted with the button part is mounted to the cabinet of the electronic apparatus in the same embodiment.

FIG. 11 is an exploded perspective view of an operation button constituted of a button part and a button frame part included in an electronic apparatus in embodiment 3.

FIG. 12 is a perspective view showing a state in which the button part and the button frame are integrally provided in the same embodiment.

FIG. 13 is a side view showing a state in which the button frame mounted with the button part is mounted to a cabinet of the electronic apparatus in the same embodiment.

FIG. 14 is a sectional view showing a state in which the button frame mounted with the button part is mounted to the cabinet of the electronic apparatus in the same embodiment.

FIG. 15 is an exploded perspective view of an operation button, constituted of a button part and a button frame part included in an electronic apparatus in embodiment 4.

FIG. 16 is a perspective view showing a state in which the button part and the button frame are integrally provided in the same embodiment.

FIG. 17 is a side view showing a state in which the button frame mounted with the button part is mounted to a cabinet of the electronic apparatus in the same embodiment.

FIG. 18 is a sectional view showing a state in which the button frame mounted with the button part is mounted to the cabinet of the electronic apparatus in the same embodiment.

### DETAILED DESCRIPTION OF THE PREFERRED EMBODIMENTS

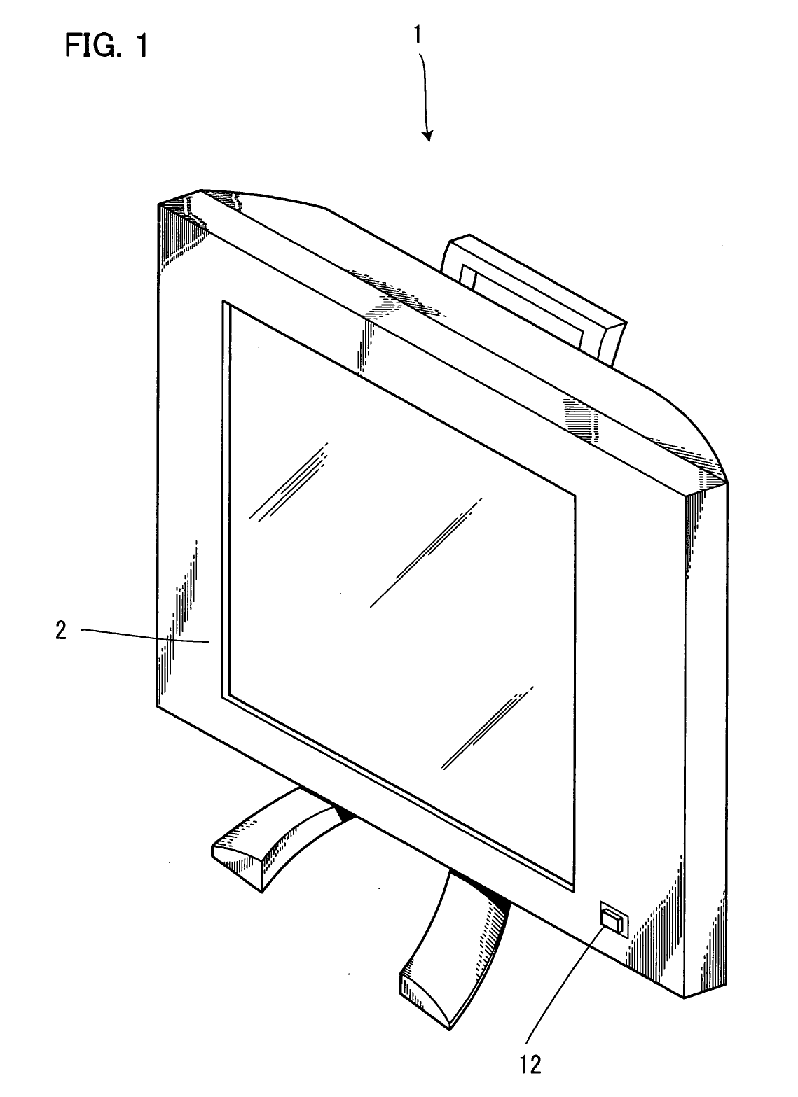

Hereinafter, embodiments as the best mode for carrying out the present invention will be described based on FIGS. 1 to 18. It naturally goes without saying that the present invention is easily applicable to the other constructions than the ones described in the embodiments within the scope which does not depart from the spirit of the invention.

### Embodiment 1

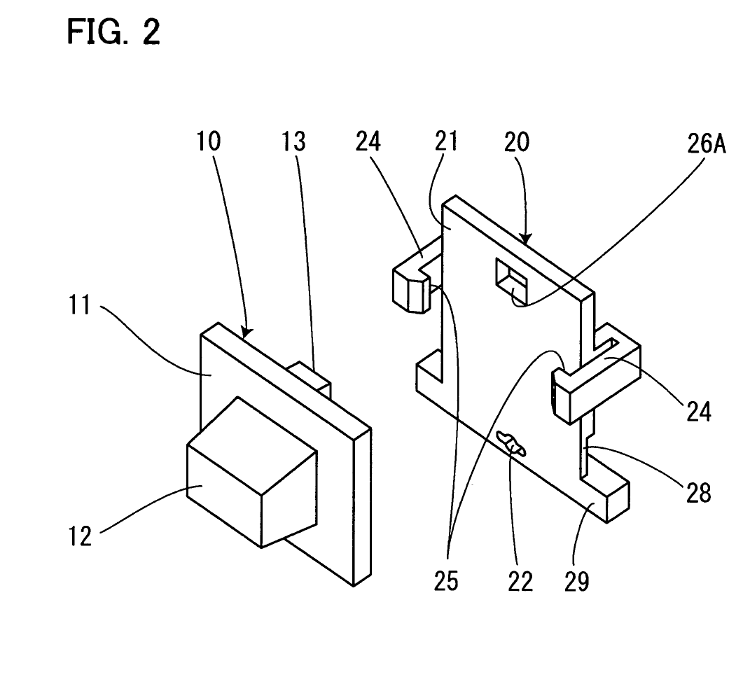

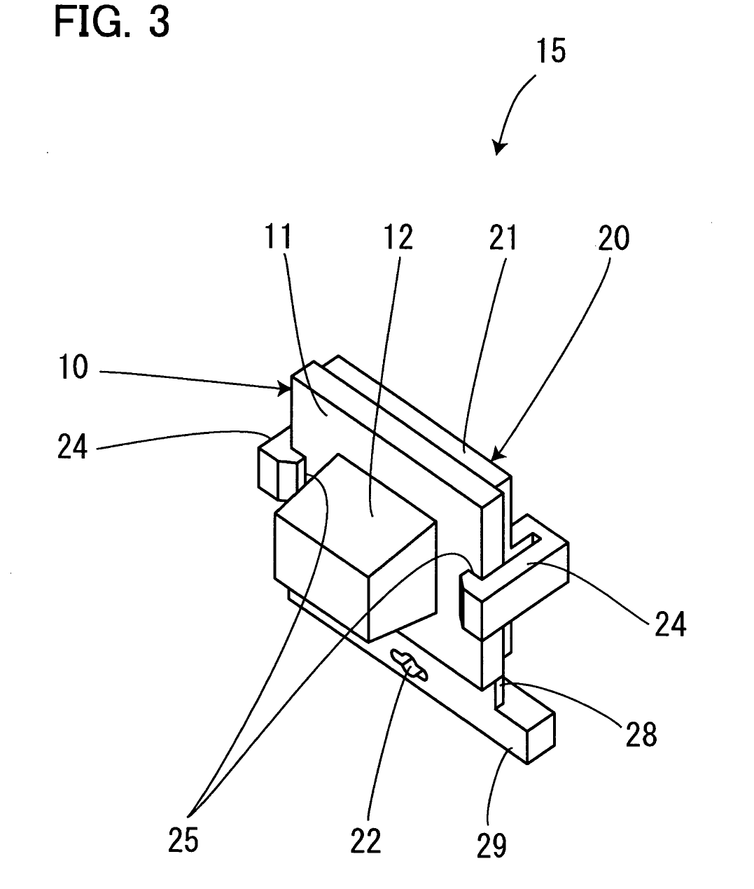

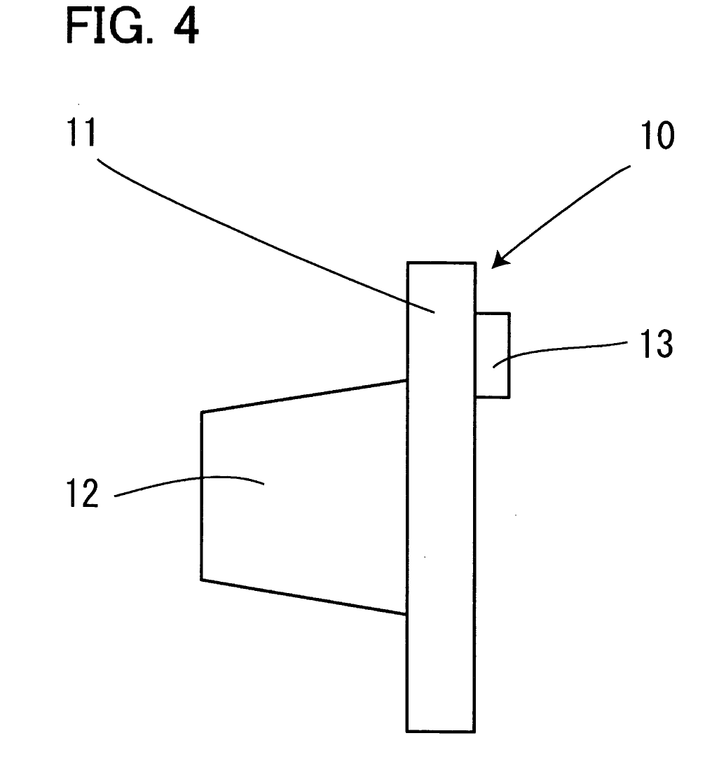

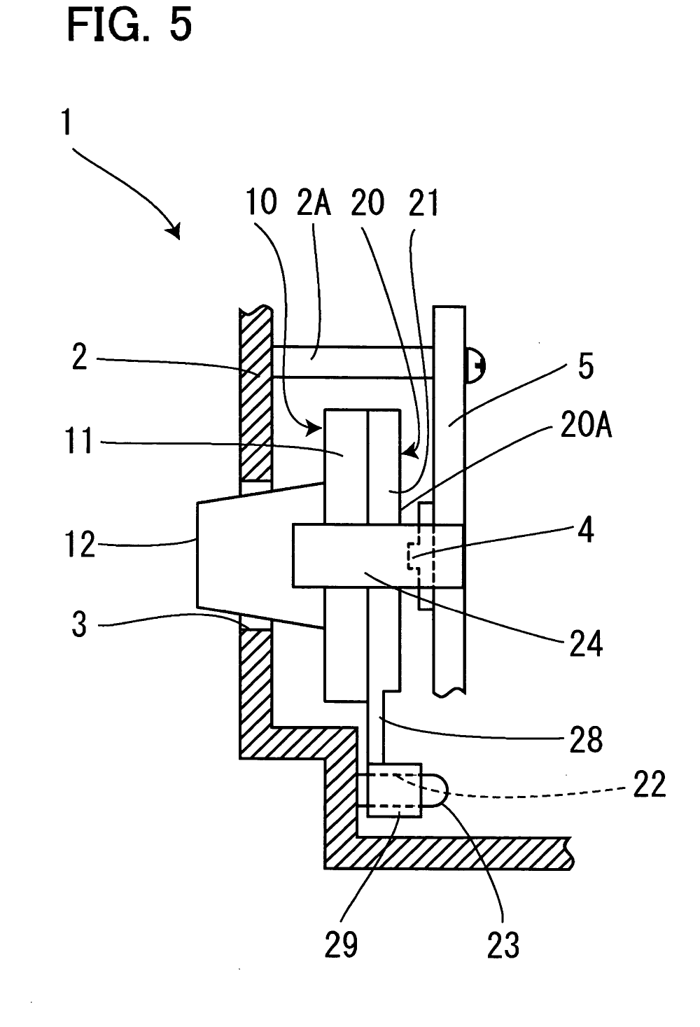

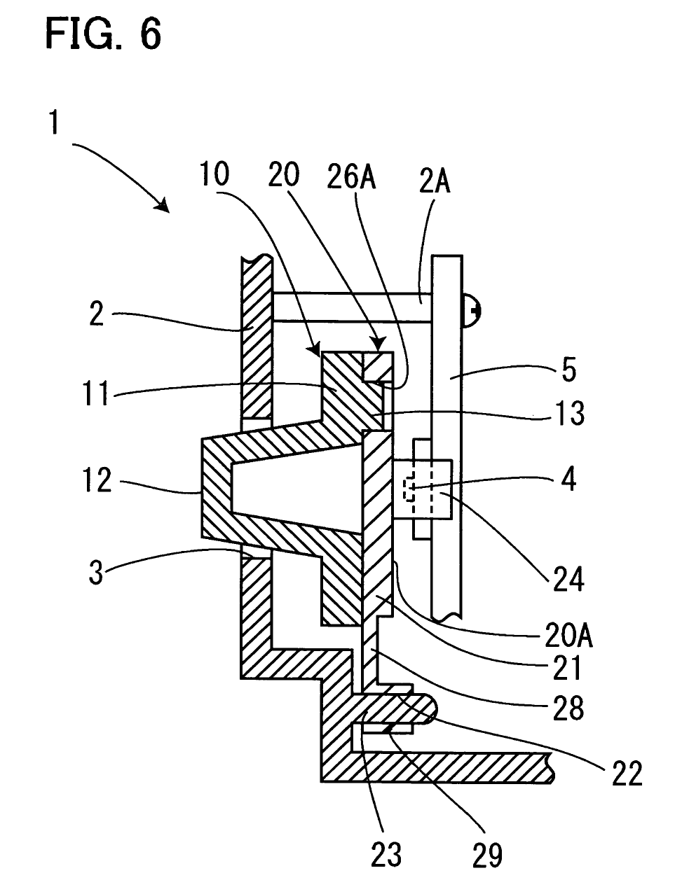

FIG. 1 is a perspective view showing an electronic apparatus in this embodiment, FIG. 2 is an exploded perspective view of an operation button constituted of a button part and a button frame included in the electronic apparatus, FIG. 3 is a perspective view showing a state in which the button part and the button frame are integrally provided, FIG. 4 is a side view of the button part, FIG. 5 is a side view showing a state in which the button frame mounted with the button part is mounted to a cabinet of the electronic apparatus, and FIG. 6 is a sectional view showing a state in which the button frame mounted with the button part is mounted to the cabinet of the electronic apparatus.

The electronic apparatus shown in FIG. 1 is a television image receiver 1 in which a length in a longitudinal direction is thinned, a button part 10 for performing an operation by directly touching it when a user or the like operates the television image receiver 1 is inserted in a hole part 3, which is formed in a cabinet 2 of the television image receiver 1, to be disposed therein to project outside from the cabinet 2, a circuit board 5 on which a plurality of electronic parts not shown are disposed is fixed to a boss part 2A formed at the cabinet 2 with a screw, and a push-button type switch 4 which is operated to turn on/off or the like of a power supply by being pressed is disposed on the circuit board 5, as shown in FIGS. 5 and 6.

In the above described button part 10, at least a button base part 11 which is a base, an operation part projection 12 which projects forward from the button base part 11, and a positioning projection 13 at a rear portion of the button base part 11 are integrally constructed as shown in FIGS. 2 to 4, a surface of the button part 10 includes a covering layer having electric conductivity of a metal, a metal alloy or the like, more specifically, plating is applied to the surface of the button part 10.

Reference numeral 20 denotes a resin button frame which does not have electric conductivity and to which the button part 10 is mounted, and the button frame 20 is mounted by fitting a hole part 22 provided at a lower portion of a base part 21, which is a base of the button frame 20, onto a projection 23 formed at the cabinet 2. Reference numeral 28 denotes a thin-walled hinge part provided at a lower portion of the button frame 20, and when the operation button 15 is operated in the state shown in FIG. 5, the base part 21 formed at the upper portion of the button frame 20 is tilted with a mounting part 29 at the lower portion of the button frame 20 as a support point by the hinge part 28, namely, when a user operates the button part 10 of the operation button 15 by pressing the button part 10 in the horizontal direction, a rear part 20A of the button frame which is brought into contact with a tip end of the switch 4 is tilted to the side of operating direction of the switch 4 (the right side shown in FIG. 5) by bending of the hinge part 28 to press the tip end of the switch 4 to turn on/off the switch.

Locking hooks 25 as locking means are provided at tip ends of extensively provided parts 24 provided to extend to a front side from both side ends of the above described base part 21. The positioning projection 13 provided at the rear portion of the button part 10 is fitted into a through-hole 26A formed in the base part 21 of the button frame 20, so that the operation button 15 constructed by the button part 10 and the button frame 20 becomes a single piece. In this embodiment, the button part 10 and the button frame 20 are positioned at a predetermined position by having a fitting part where the positioning projection 13 of the button par 10 and the through-hole 26A of the base part 21 of the button frame 20 are fitted to each other, but the present invention is not especially limited to this construction, and it is possible to make various modifications such as providing the thorough-hole 26A in the button part 10 and providing the positioning projection 13 at the button frame 20, or forming a simply recessed part 26 which does not penetrate longitudinally through the base part 21 instead of the through-hole 26A, or the like if only the button part 10 and the button frame 20 can be positioned to each other. The above described extensively provided part 24 is in bent shape so that the extensively provided part 24 easily bends so that the locking hook 25 is easily locked at the button base part 11 when the button part 10 is mounted to the button frame 20, and the extensively provided parts 24 can reliably hold the button part 10 by utilizing a restoring force of the extensively provided parts 24.

As described above, according to the above described construction, in the television image receiver 1, the operation button 15 is constructed by the button part 10 which is operated by directly touching it and the button frame 20 mounted with the button part 10 and turns on and/or off the switch 4 by pressing the switch 4 disposed at the circuit board 5 inside the cabinet 2 of the television image receiver 1 as separate members, the operation button is disposed with the operation part projection 12 of the above described button part 10 projected from the hole part 3 formed in the cabinet 2 of the television image receiver 1, the locking means such as the hooked locking hooks 25 are provided at the front surface side of the button frame 20, the button base part 11 of the button part 10 is locked by the locking hooks 25 of the button frame 20, and the button part 10 and the button frame 20 are integrally provided.

Since the button part 10 can be mounted to the button frame 20 by the locking means such as the locking hooks 25, and in the state in which the button part 10 is mounted to the button frame 20, the locking hooks 25 being the locking means are not disposed at the back surface side of the button frame 20, it becomes possible to secure a space part at the rear of the button frame 20 in the cabinet 2, and since the tip end portions and the like of the locking hooks 25 do not project to the back surface side of the button frame 20, the switch 4 or the like can be disposed in the state in which it is close to the rear part 20A of the button frame 20, as a result of which, the button frame 20 and the circuit board 5 on which the components such as the switch 4 are disposed can be disposed with a space between them made small, therefore, making it possible to reduce the space between the button frame 20 and the circuit board 5, thus making it possible to downsize the television image receiver 1 which is the electronic apparatus.

Further, since the surface of the button part 10 includes a covering layer having electric conductivity, and the material of the button frame 20 is made of the resin which does not have electric conductivity, even if the button part 10 is in the charged state by static electricity or the like in the state in which the button part 10 including the covering layer having electric conductivity on its surface is mounted to the resin button frame 20, the static electricity charged on the button part 10 can be shut off by the button frame 20 which does not have electric conductivity, and therefore, even if the switch 4 or the like is disposed close to the back surface side of the button frame 20, a short circuit by static electricity to the circuit board 5 on which the switch 4 is disposed from the button part 10 via the switch 4 can be prevented. As for the surface of the button part 10 in this embodiment, plating is applied to the surface as the covering layer having electric conductivity, but the covering layer is not especially limited to this, and various modifications such as providing the covering layer by putting a metal cap on the resin button part 10, or adopting a metal alloy as the material of the button part 10 itself can be made.

Further, the locking hooks 25 are brought into contact with the base part 11 and the locking hooks 25 are locked at the base part 11 by deforming the extended provided parts 24 of the button frame 20 by bending the extended provided parts 24 when the button frame 20 and the button part 10 are integrally mounted, and since the surface of the button part 10 includes the covering layer with electric conductivity of a metal, a metal alloy or the like, it is possible to make a friction coefficient of the contact part of the locking hooks 25 and the button part 10 smaller than the contact of resin members, as a result of which, the button part 10 can be smoothly mounted to the button frame 20, concentrated application of a force to a part of the locking hooks 25 and the extensively provided parts 24 during such mounting can be reduced, and it is possible to avoid risk of breakage of the locking hooks 25 and the extensively provided parts 24.

### Embodiment 2

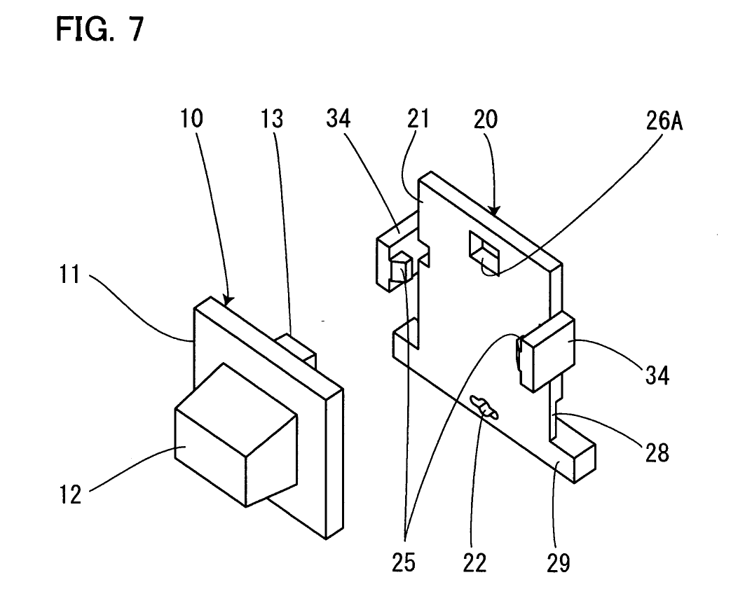

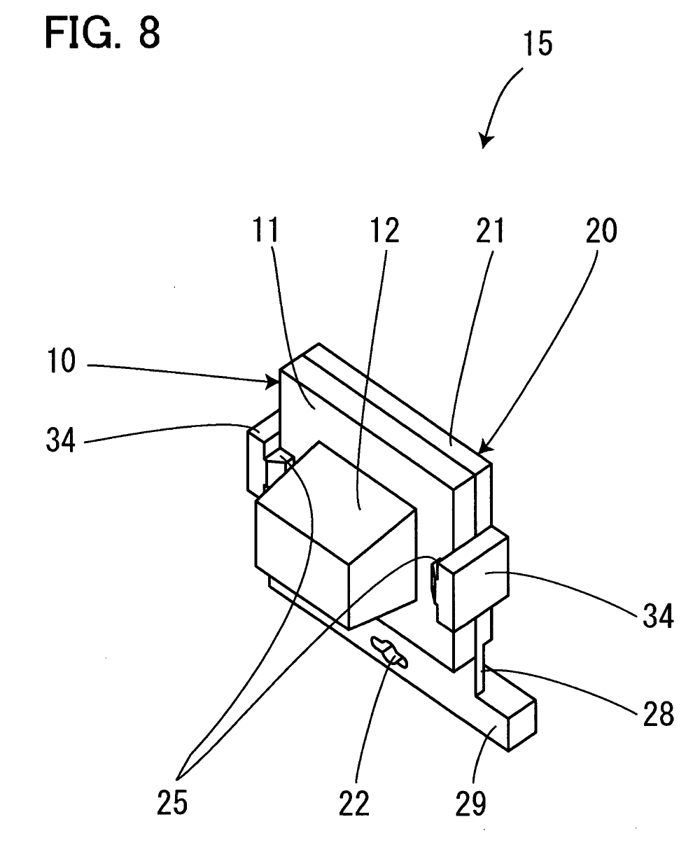

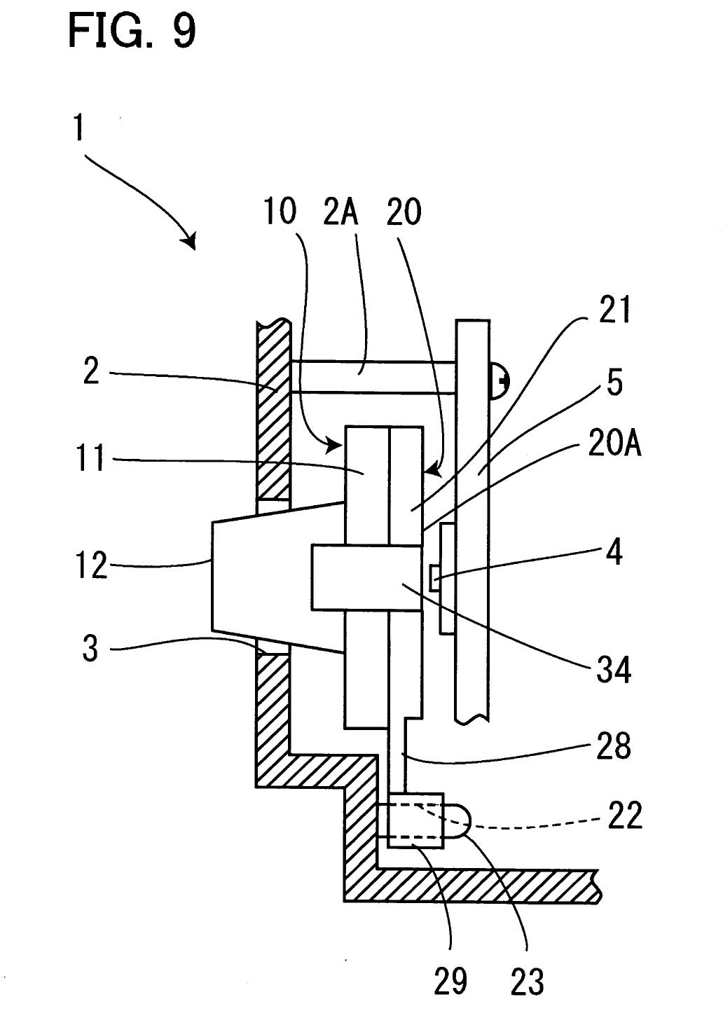

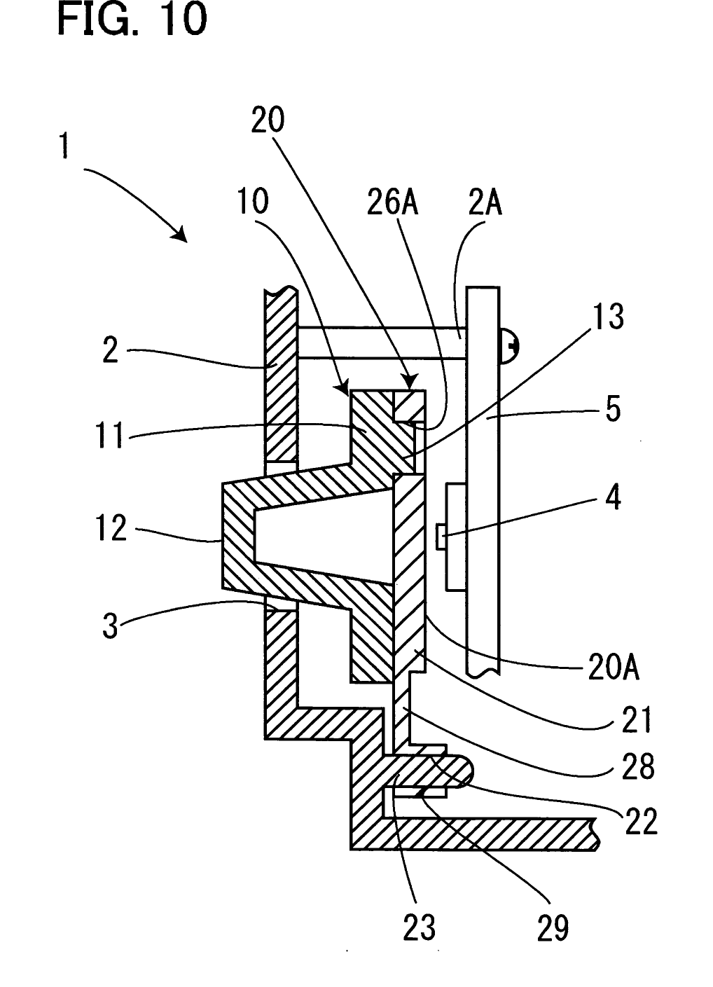

FIGS. 7 to 10 show an embodiment 2 of the present invention, FIG. 7 is an exploded perspective view of an operation button constituted of a button part and a button frame included in an electronic apparatus, FIG. 8 is a perspective view showing a state in which the button part and the button frame are integrally provided, FIG. 9 is a side view showing a state in which the button frame mounted with the button part is mounted to a cabinet of the electronic apparatus, and FIG. 10 is a sectional view showing a state in which the button frame mounted with the button part is mounted to the cabinet of the electronic apparatus, and the embodiment 2 will be described hereinafter based on FIGS. 7 to 10. The same parts as those in the above described embodiment 1 are given the same reference numerals and the detailed explanation will be omitted. In this embodiment, only the shape of an extensively provided part 34 differs from that of the extensively provided part 24 of the embodiment 1, the extensively provided part 34 of this embodiment which differs from the extensively provided part 24 in shape is formed linearly to the button part 10 side from the base part 21 of the button frame 20 as shown in FIGS. 7 and 8, and therefore, the extensively provided part 34 is not disposed with a part of the extensively provided part 34 projected to the rear side from the rear part 20A which is brought into contact with the switch 4 as shown in FIGS. 9 and 10, so that the entire rear portion of the operation button 15 is formed into a planar shape. Namely, the switch 4 can be disposed close to any position of the entire rear portion of the operation button, and therefore, the degree of freedom of design can be enhanced.

### Embodiment 3

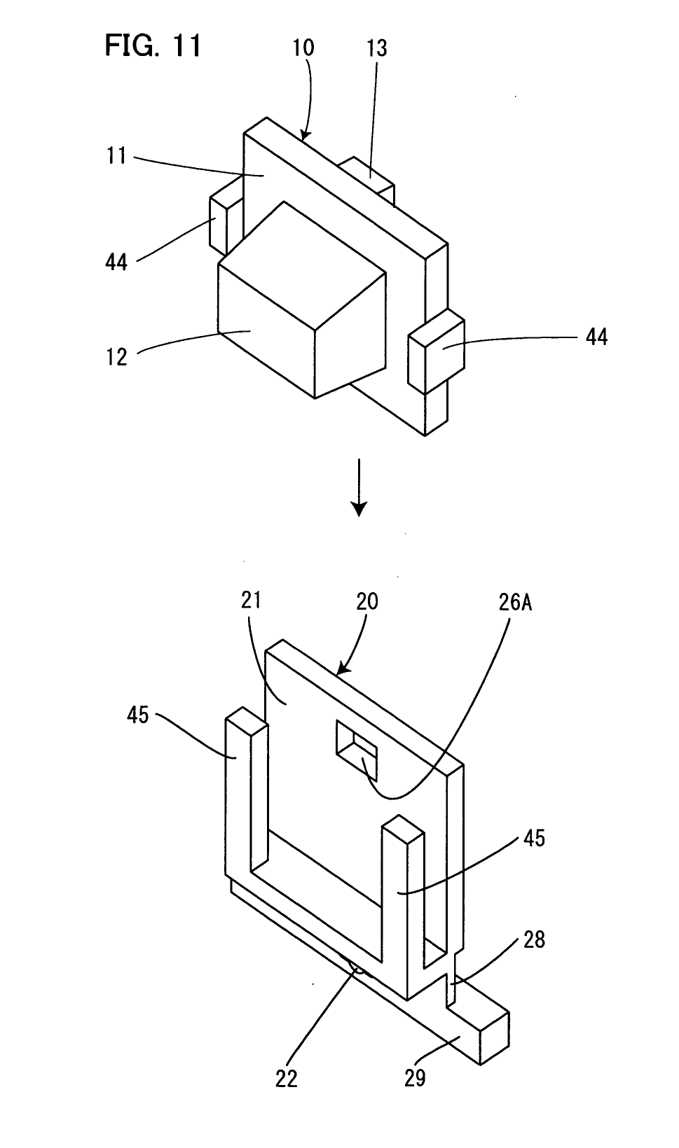

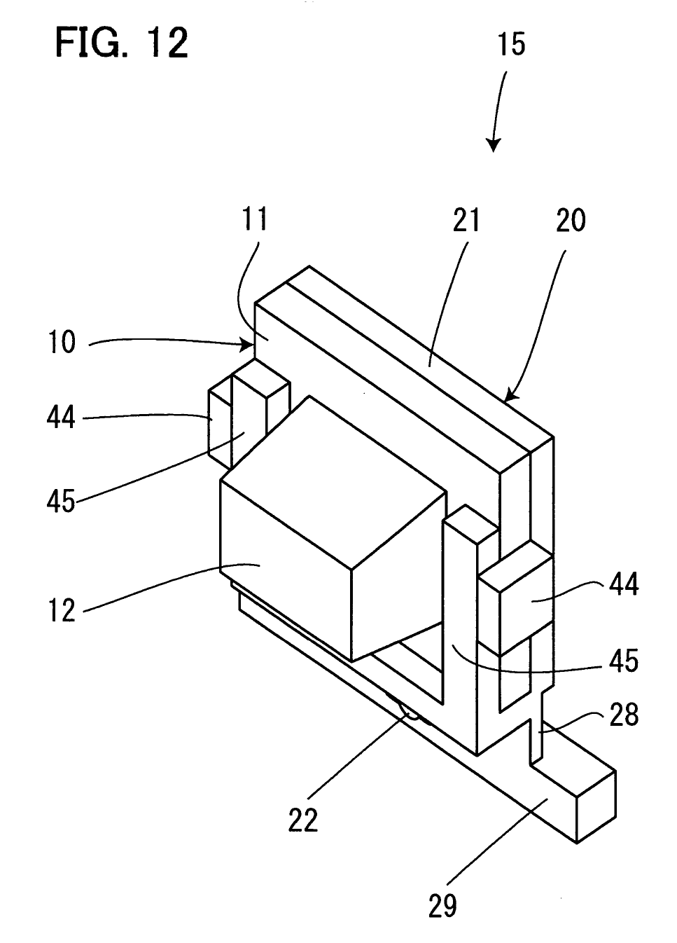

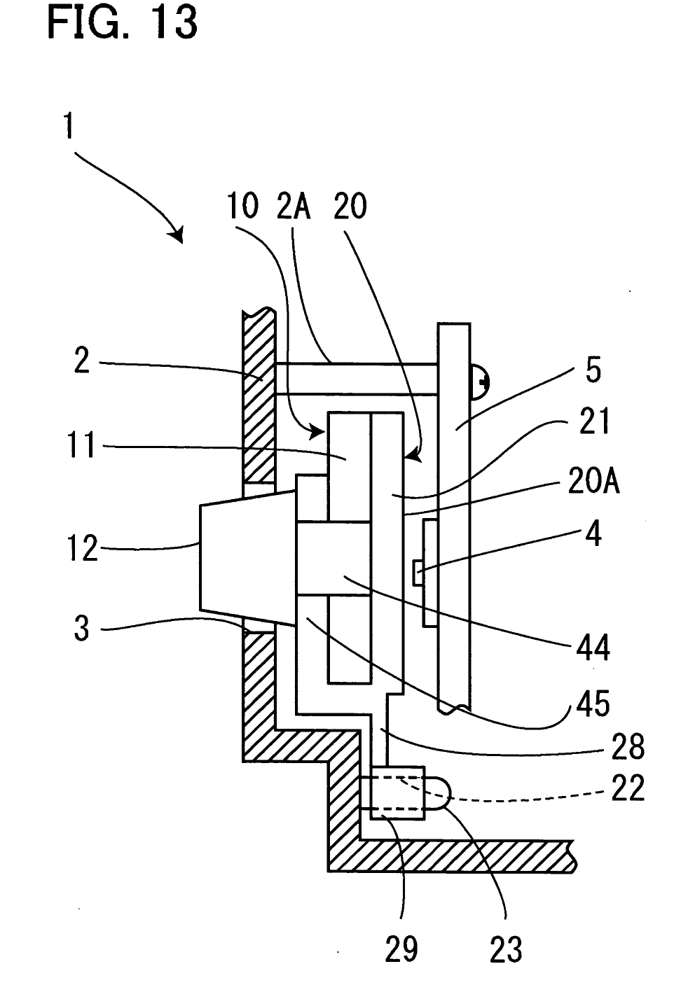

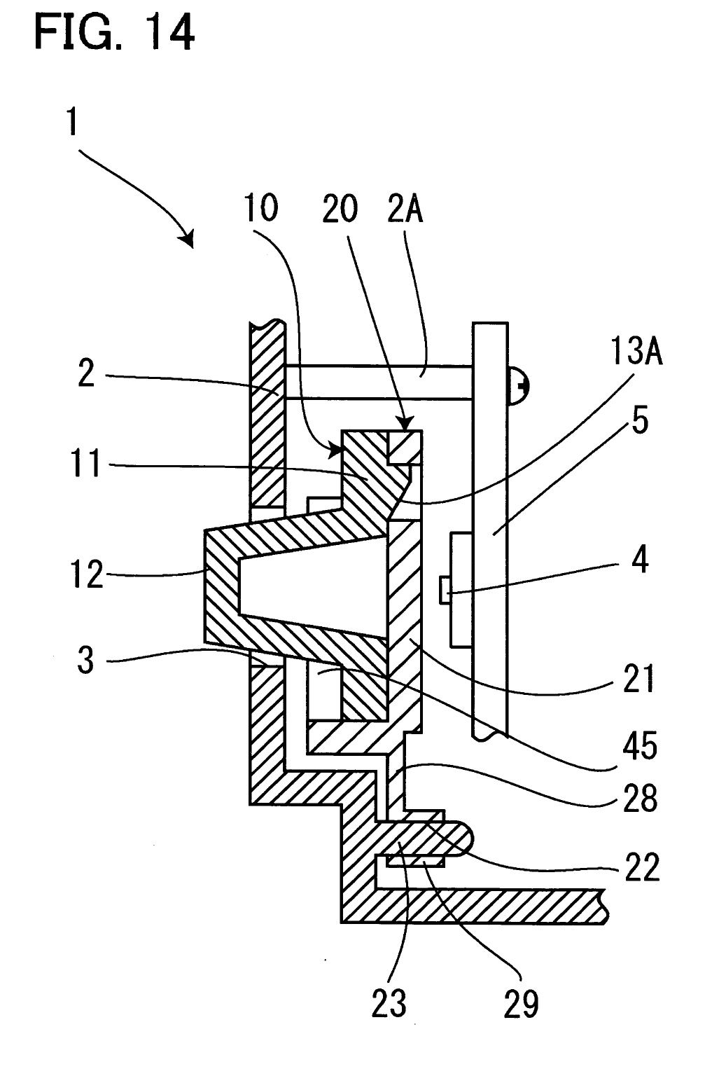

FIGS. 11 to 14 show an embodiment 3 of the present invention, FIG. 11 is an exploded perspective view of an operation button constituted of a button part and a button frame included in an electronic apparatus, FIG. 12 is a perspective view showing a state in which the button part and the button frame are integrally provided, FIG. 13 is a side view showing a state in which the button frame mounted with the button part is mounted to a cabinet of the electronic apparatus, and FIG. 14 is a sectional view showing a state in which the button frame mounted with the button part is mounted to the cabinet of the electronic apparatus, and the embodiment 3 will be described hereinafter based on FIGS. 11 to 14. The same parts as those in the above described embodiments 1 and 2 are given the same reference numerals and the detailed explanation will be omitted. In this embodiment, guide ribs 45 vertically provided from a lower position at a front surface side of the button frame 20 are provided instead of the locking hooks 25 as the locking means, guide projections 44 provided to project forward from both sides of the button base part 11 of the button part 10 are formed, and by sliding the button part 10 in the arrow direction shown in FIG. 11 from above the button frame 20 and locking the button part 10 between the guide ribs 45 and the base part 21 of the button frame 20, the button frame 20 and the button part 10 are integrated. In this embodiment, an inclined part 13A is formed at the positioning projection 13 as shown in FIGS. 11 and 14, and therefore, the button base part 11 can be smoothly slid and mounted between the guide ribs 45 and the base part 21.

### Embodiment 4

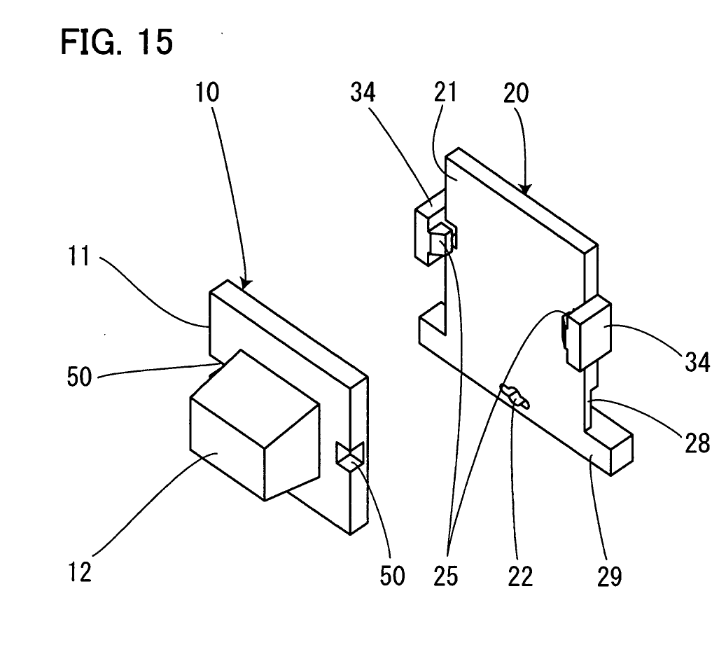

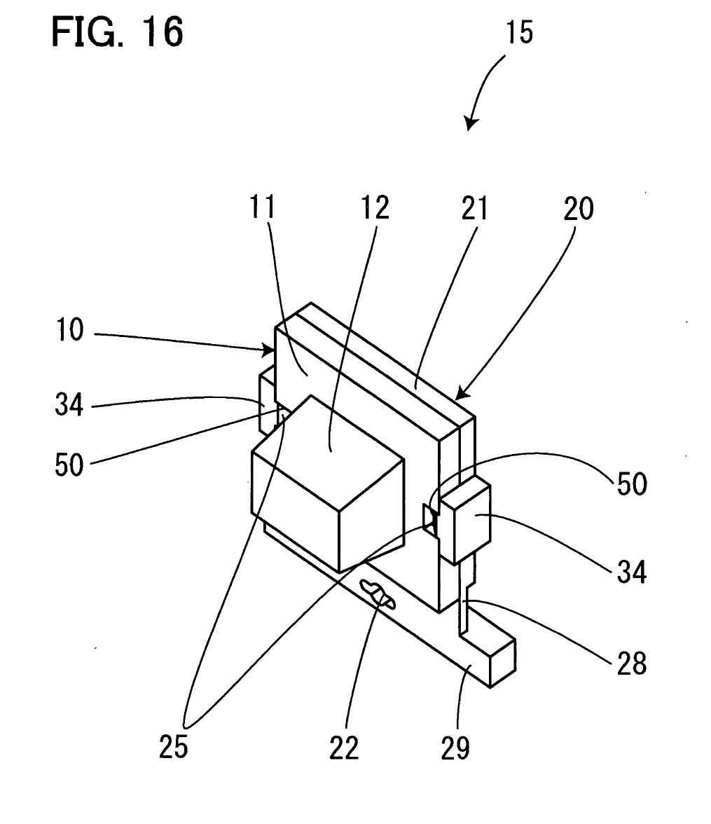

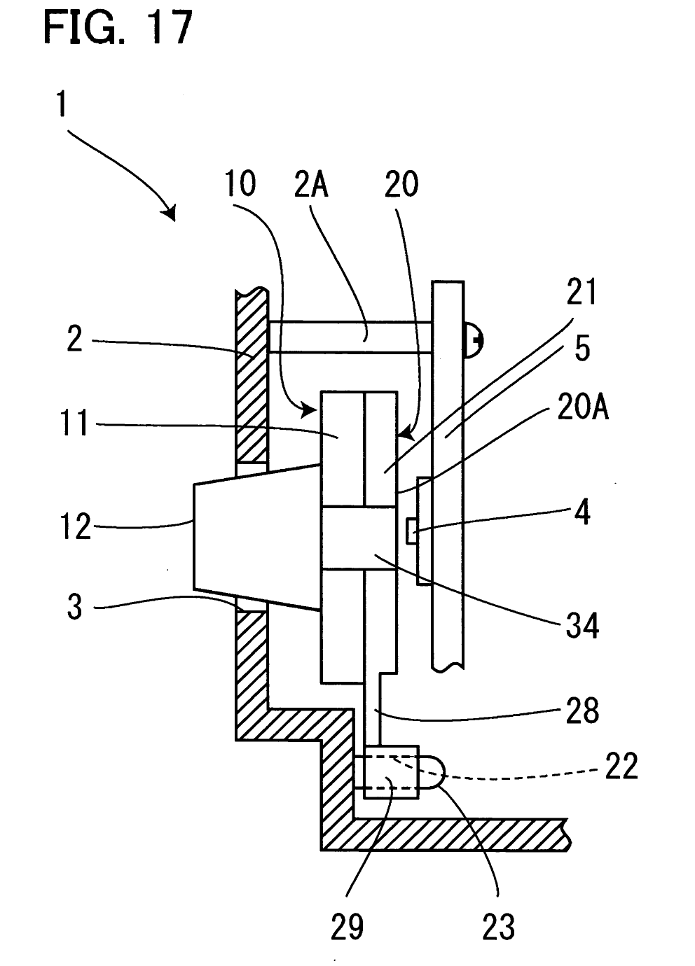

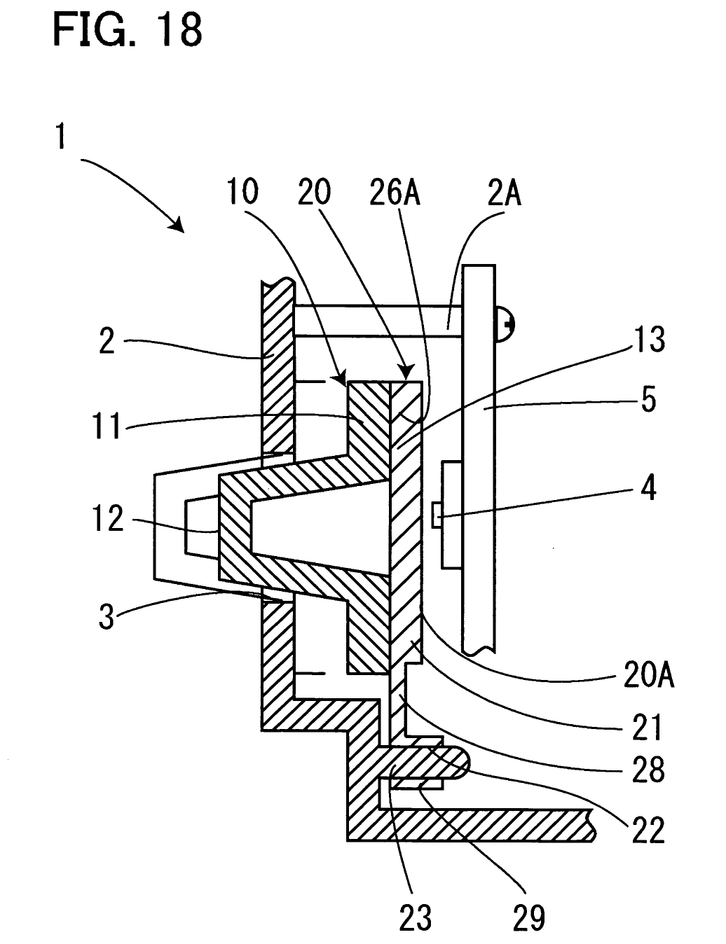

FIGS. 15 to 18 show an embodiment 4 of the present invention, FIG. 15 is an exploded perspective view of an operation button constituted of a button part and a button frame included in an electronic apparatus, FIG. 16 is a perspective view showing a state in which the button part and the button frame are integrally provided, FIG. 17 is a side view showing a state in which the button frame mounted with the button part is mounted to a cabinet of the electronic apparatus, and FIG. 18 is a sectional view showing a state in which the button frame mounted with the button part is mounted to the cabinet of the electronic apparatus, and the embodiment 4 will be described hereinafter based on FIGS. 15 to 18. The same parts as those in the above described embodiment 2 and the like are given the same reference numerals and the detailed explanation will be omitted. In this embodiment, the shape of the button frame 20 is substantially the same as that in the embodiment 2, but the positioning projection 13 and the through-hole 26A are not provided, and by forming locking recessed parts 50 at both side portions of the button base part 11, and by locking the locking hooks 25 at the locking recessed parts 50, positioning of the button part 10 and the button frame 20 is performed, and the button frame 20 and the button part 10 are integrated with each other, thus making it possible to reduce the dimension in the length direction than the length in the longitudinal direction of the extensively provided part 34 of the embodiment 2.

According to the electronic apparatus including an operation button of claim 1 or 2 of the present invention, in the electronic apparatus including an operation button constructed by the button part which is operated by directly touching it and the button frame which is mounted with the button part and turns on/off the switch by pressing the switch disposed at the board inside the electronic apparatus as the separate members, the aforesaid button part is disposed in the state in which the button part is projected from the hole part formed in the cabinet of the electronic apparatus, the locking means such as the hooked locking hooks are provided at the front surface side of the aforesaid button frame, the aforesaid button part is locked by the locking means, and the aforesaid button part and the aforesaid button frame are integrally provided. Therefore, since the space part can be secured at the rear of the button frame when the button part is mounted to the button frame, and the tip end portions or the like of the locking hooks do not project to the back surface side of the button frame, and therefore, the switch and the like can be disposed in the state close to the rear portion of the button frame, as a result of which, the operation button can be disposed by making the space between the button frame and the circuit board on which the switch or the like is disposed small, and therefore, it is possible to make the space between the button frame and the board small, thus making it possible to downsize the entire electronic apparatus.

According to the electronic apparatus including the operation button of claim 3 of the present invention, in the electronic apparatus including an operation button according to claim 1 or 2, a covering layer having electric conductivity is included on a surface of the aforesaid button part, and a material of the aforesaid button frame is made of a resin which does not have electric conductivity, and since static electricity charged at the button part can be shut off by the button frame which does not have electric conductivity, a short circuit by static electricity to the board via the switch from the button part can be prevented even if the switch is disposed at the back surface side of the button frame, thus making it possible to prevent the electronic apparatus from failing.

1. An electronic apparatus including an operation button constructed by a button part which is operated by directly touching it and a button frame which is mounted with the button part and turns on/off a switch by pressing the switch disposed at a board inside the electronic apparatus as separate members, characterized in that said button part is disposed in a state in which the button part is projected from a hole part formed in a cabinet of the electronic apparatus, locking means are provided at a front surface side of said button frame, said button part is locked by the locking means, and said button part and said button frame are integrally provided.

2. The electronic apparatus including an operation button according to claim 1, wherein said locking means are hooked locking hooks.

3. The electronic apparatus including an operation button according to claim 1, wherein a covering layer having electric conductivity is included on a surface of said button part, and a material of said button frame is made of a resin which does not have electric conductivity.

4. The electronic apparatus including an operation button according to claim 2, wherein a covering layer having electric conductivity is included on a surface of said button part, and a material of said button frame is made of a resin which does not have electric conductivity.
